(19) United States
(12) Patent Application Publication
(10) Pub. No.: US 2008/0242261 A1
(43) Pub. Date: Oct. 2, 2008

(54) EMERGENCY RESCUE SYSTEM, EMERGENCY RESCUE METHOD, MOBILE PHONE DEVICE FOR EMERGENCY RESCUE, AND COMPUTER PROGRAM PRODUCT FOR EMERGENCY RESCUE

(76) Inventors: MASAHIRO SHIMANUKI, Tokyo (JP); Naoyuki Amano, Tokyo (JP); Toru Owai, Tokyo (JP)

Correspondence Address: NEC CORPORATION OF AMERICA, 6535 N. STATE HWY 161, IRVING, TX, 75039, US

(21) Appl. No.: 12/055,836

(22) Filed: Mar. 26, 2008

(30) Foreign Application Priority Data
Mar. 30, 2007 (JP) 2007-090178

(51) Int. Cl. H04M 11/04

(52) U.S. Cl. 455/404.2

(57) ABSTRACT

Disclosed is an emergency rescue system comprising a mobile terminal device and a control center. The mobile terminal device includes: a sender unit capable of sending an electrical mail; an abnormality sensor which detects an abnormality in an outer environment; a GPS receiver which generates GPS positional information; and a control unit which judges whether a level of sensing of the abnormality sensed by the abnormality sensor is not smaller than a predetermined threshold value. The control center judges a state of accident based on both a satellite image and the GPS positional information attached to the template mail sentence received from the mobile terminal device.

This application is based on Japanese patent application No. 2007-090178 filed Mar. 30, 2007, the content of which is incorporated herein by reference.

### BACKGROUND

1. Technical Field

The present invention relates to a system, method, mobile phone device and computer program product for emergency rescue.

2. Related Art

In general traffic accident, and in case of encounter with debris flow, flood damage and so forth, one may not make a contact even if he or she had a waterproof mobile phone device, due to the following reasons: 1) the sufferer may not be in a state capable of making a contact (seriously damaged, for example), even if he or she should have a mobile phone device; 2) the sufferer may be confused enough to lose an idea of using a mobile phone device; and 3) the sufferer may not know where the mobile phone device is, even if he or she should have it.

In these situations, the sufferer might be rescued if he or she could be able to make a contact more earlier.

Another problems is that safety of the owner of a mobile phone device cannot be confirmed simply by collating the mobile phone having a function of sending positional information together with accident information, because the situation cannot be discriminated from the case where the owner was merely a witness of the accident and was safe.

Therefore, proposals have been made on increasing opportunities of rescue, in the scenes where rescue delayed because the sufferer trapped in an accident or hazard could not make a contact because he or she was forcedly left motionless, or could not inform a rescue team that he or she was still alive, even if the rescue team came close to the sufferer. These are scenes that “the sufferers should have been saved if their mobile phone devices were effectively used”.

Japanese Patent Application Publication No. 2006-279837 discloses a portable communication device having an impact sensor detecting impact, pressure, light and humidity, configured as being switchable to an emergency operation mode upon detection of impact, so as to continuously and successively sending a mail containing message sentences preliminarily stored in a memory to an address preliminarily stored in the memory, while incorporating positional information acquired through a GPS, into the message.

Japanese Patent Application Publication No. 2003-078654 discloses a posting system having an imaging device taking a picture of a part of a moving object and the periphery thereof, an impact sensor detecting impact applied to the moving object, and a recorder recording and storing video signals before and after the time of impact detection based on results of detection, configured so as to allow the impact sensor to detect impact, make a contact to an emergency information center to thereby call out an ambulance, fire-fighting car, wrecker and the like, judge a state of the accidental site based on positional information obtained through a GPS and video signals of the accident, and send thus stored video signals to a rescue call center.

Japanese Patent Application Publication No. 2004-078393 discloses an emergency response system having a function of judging a level of accident based on information obtained through a GPS navigation system and a vehicle sensor, and generating an accident response system information, a function of automatically sending, upon occurrence of traffic accident, the accident response system information through the Internet to computers at police station, fire station and nonlife insurance company, and a function of automatically making a contact with mobile phone devices of the family, and configured so as to automatically make contact with police station, fire station, nonlife insurance company and family, upon detection by an impact sensor.

Japanese Patent Application Publication No. 2000-209313 discloses a mobile phone device outputting, upon detection of an impact equivalent to or larger than a predetermined threshold value by an impact sensor, an alarm sound through a loudspeaker depending on conditions preliminarily set thereto.

Japanese Patent Application Publication No. 2000-307460 discloses a portable communication terminal posting an emergency message in a form of sound or character information to a preset emergency call destination, upon detection by an impact sensor.

Japanese Patent Application Publication No. 2001-141466 discloses a positional information management terminal sending pictures of state of accident taken by a camera to a control terminal, and displaying them together with positional information obtained by a GPS receiver.

Japanese Patent Application Publication No. 2004-080540 discloses a mobile phone device switchable through remote control to the hands-free mode, even when the user cannot operate the mobile phone device.

The individual conventional techniques have, however, been suffering from the problems below.

The portable communication device disclosed in Japanese Patent Application Publication No. 2006-279837 is useful only to as far as posting occurrence of accident, but cannot allow the called party to identify state of the accident, so that quick and appropriate response under urgent conditions will not be available.

The posting system disclosed in Japanese Patent Application Publication No. 2003-078654 transmits video signals, and thereby allows understanding of a state of accident through a video image, but judgment of the state depends on human skills, rather than being made exactly on the data-basis.

The emergency response system disclosed in Japanese Patent Application Publication No. 2004-078393 is dedicated to responses for vehicle accidents handling data of vehicle speed when an accident, in particular, a vehicle accident occurred, appropriate use of a seat belt, a method of collating a database in a nonlife insurance company and so forth, so that it is impossible to posting or confirming situations of owners of mobile phone devices, other than the vehicle owner, encountered with the accident.

The mobile phone device disclosed in Japanese Patent Application Publication No. 2000-209313 cannot allow the called party, upon detection of impact by the mobile phone device, to identify situations of accident, and therefore cannot make a rapid and appropriate response in an urgent situation.

Japanese Patent Application Publication No. 2000-307460 discloses the portable communication terminal only to as far as procedures from occurrence of accident to making of call, but again the called party cannot identify situations of the accident, and therefore cannot make a rapid and appropriate response in an urgent situation.

The positional information management terminal disclosed in Japanese Patent Application Publication No. 2001-141466 is configured as sending pictures, taken by a sufferer of accident, together with positional information, but it is not practical to expect the sufferer of accident to take pictures. Moreover, the terminal is on the premise that the owner of vehicle encounters an accident during the driving, so that it is impossible to posting or confirming situations of owners of mobile phone devices, other than the vehicle owner, encountered with the accident.

The mobile phone device Disclosed in Japanese Patent Application Publication No. 2004-080540 can save the power consumption thereof in the process over which the owner of mobile phone device encounters an accident and rescued, and allows a rescue team to confirm safety of the owner of mobile phone device, but cannot make a contact after the user of mobile phone device encountered an accident, and cannot judge whether the situation needs rescue, proving only a limited degree of practical response.

### SUMMARY

In view of the foregoing, it is an object of the present invention to provide a system, method, mobile phone device and computer program product for emergency rescue for detecting an accident or hazard that is encountered, and enabling sending of information in connection with positional information thereby to detect a situation of the accident or hazard with a high accuracy.

According to the present invention, there is provided an emergency rescue system comprising a mobile terminal device and a control center. The mobile terminal device includes: a memory which stores data representing a predetermined designated call destination and data representing a template mail sentence for emergency call; a sender unit capable of sending an electrical mail; an abnormality sensor which detects an abnormality in an outer environment; a GPS receiver which generates GPS positional information; and a control unit which judges whether a level of sensing of the abnormality sensed by the abnormality sensor is not smaller than a predetermined threshold value. The control unit, if the level is judged as being not smaller than the threshold value, reads the data representing a template mail sentence for emergency call and the data representing a predetermined designated call destination from the memory, and causes the sender to send an electrical mail containing the read data representing the template mail sentence together with the GPS positional information attached to the template mail sentence, to an address specified by the read data representing the designated call destination. The control center judges a state of accident based on both a satellite image and the GPS positional information attached to the template mail sentence received from the mobile terminal device.

According to the present invention, there is provided a mobile phone device which comprises: a memory which stores data representing a predetermined designated call destination and data representing a template mail sentence for emergency call; a sender unit capable of sending a mail; an abnormality sensor which detects an abnormality in an outer environment; a GPS receiver which generates GPS positional information; and a control unit which judges whether a level of sensing of the abnormality sensed by the abnormality sensor is not smaller than a predetermined threshold value. The control unit, if the level is judged as being not smaller than the threshold value, reads said data representing a template mail sentence for emergency call and said data representing a predetermined designated call destination from said memory, and causes said sender to send an electrical mail containing the read data representing the template mail sentence, to an address specified by the read data representing the designated call destination. The data representing the designated call destination contains data representing either or both of a unique designated call destination and a variable designated call destination. The control unit updates said variable designated call destination to a nearest call destination based on said GPS positional information.

According to the present invention, there is provided an emergency rescue method using a mobile terminal device. The mobile terminal device comprises: a memory which stores data representing a predetermined designated call destination and data representing a template mail sentence for emergency call; a sender unit capable of sending an electrical mail; an abnormality sensor which detects an abnormality in an outer environment; and a GPS receiver which generates GPS positional information. The emergency rescue method comprises: judging whether a level of sensing of the abnormality sensed by the abnormality sensor is not smaller than a predetermined threshold value; if the level is judged as being not smaller than the threshold value, reading the data representing a template mail sentence for emergency call and the data representing a predetermined designated call destination from the memory, and causing the sender to send an electrical mail containing the read data representing the template mail sentence together with the GPS positional information attached to the template mail sentence, to an address specified by the read data representing the designated call destination; and judging a state of accident based on both a satellite image and the GPS positional information attached to the template mail sentence received from the mobile terminal device.

According to the present invention, there is provided a computer program product for emergency rescue which is executed by a processor by using a mobile terminal device. The mobile terminal device includes: a memory which stores data representing a predetermined designated call destination and data representing a template mail sentence for emergency call; a sender unit capable of sending an electrical mail; an abnormality sensor which detects an abnormality in an outer environment; a GPS receiver which generates GPS positional information; and a control unit which judges whether a level of sensing of the abnormality sensed by the abnormality sensor is not smaller than a predetermined threshold value. The control unit, if the level is judged as being not smaller than the threshold value, reads the data representing a template mail sentence for emergency call and the data representing a predetermined designated call destination from the memory, and causes the sender to send an electrical mail containing the read data representing the template mail sentence together with the GPS positional information attached to the template mail sentence, to an address specified by the read data representing the designated call destination. The computer program product comprises: code for receiving the GPS positional information from the mobile terminal device attached to the template mail sentence; and code for judges a state of accident based on both a satellite image and the received GPS positional information.

The abnormality sensor can sense at least one abnormality selected from an externally-applied impact, environmental temperature, smoke and water.

The data representing the designated call destination can contain data representing either or both of a unique designated call destination and a variable designated call destination. The control unit can update said variable designated call destination to a nearest call destination based on said GPS positional information.

The data representing the unique designated call destination can contain data representing at least one of affiliated companies, family and home. The data representing the variable designated call destination can contain data representing at least one of a nearest police station, fire station and hospital at the time of accident.

The mobile terminal device can have either one or both of a notifier and a sound generator. The notifier notifies of contents of said template mail sentence and an emergency message in an artificial voice. The sound generator generates an alarm sound.

The mobile terminal device can be capable of operating in a hands-free mode.

The GPS positional information can be attached to the template mail sentence.

The mobile phone device can be capable of operating in a hands-free mode.

According to the present invention, in the emergency rescue system, the emergency rescue method, and the computer program product using the mobile terminal device, a rescue operation for not only owners of mobile phone devices or mobile terminal devices who posted a call, but also for other large number of sufferers typically in train crash, disaster, hazard or the like, can be expected, and thereby rapid rescue operation can be available.

For the case where the mobile phone device or mobile terminal device having a function of sending positional information is carried by the owner, whether the owner encounters an accident or is a mere witness at the site of accident can be discriminated and its information can be sent, so that information representing situations in need of rescue can be sent in an automatic and appropriate manner.

The mobile phone device or mobile terminal device can also be prevented from being lost, because dropping of the device will activate an alarm.

According to the present invention, in the emergency rescue system, the emergency rescue method, and the computer program product using the mobile terminal device, an accident or hazard can be detected if the owner encounters the accident or hazard, and information representing the detected accident or hazard can be sent as being liked with positional information, and thereby situations of accident can be detected with a high level of accuracy.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a schematic front elevation showing a mobile phone device that is a mobile terminal device according to an embodiment of the present invention;

FIG. 2 is a block circuit diagram of a mobile phone device as a mobile terminal device according to an embodiment of the present invention;

FIG. 3 is a flow chart showing processing operations of a program allowing execution of an emergency rescue method using a mobile terminal device according to an embodiment of the present invention;

FIG. 4 is a schematic drawing of the entire configuration of an emergency rescue call system according to an embodiment of the present invention; and

FIG. 5 is another flow chart showing processing operations of a program allowing execution of an emergency rescue method using a mobile terminal device according to an embodiment of the present invention.

### DETAILED DESCRIPTION

The invention will now be described herein with reference to an illustrative embodiments. Those skilled in the art will recognize that many alternative embodiments can be accomplished using the teachings of the present invention and that the invention is not limited to the embodiment illustrated for explanatory purposes.

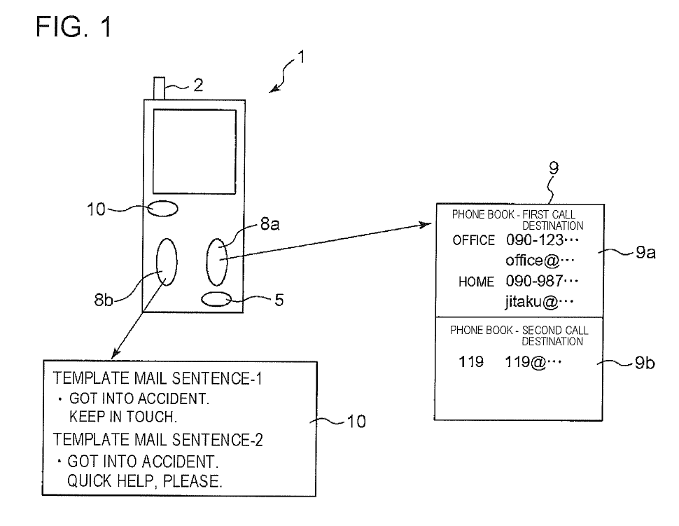

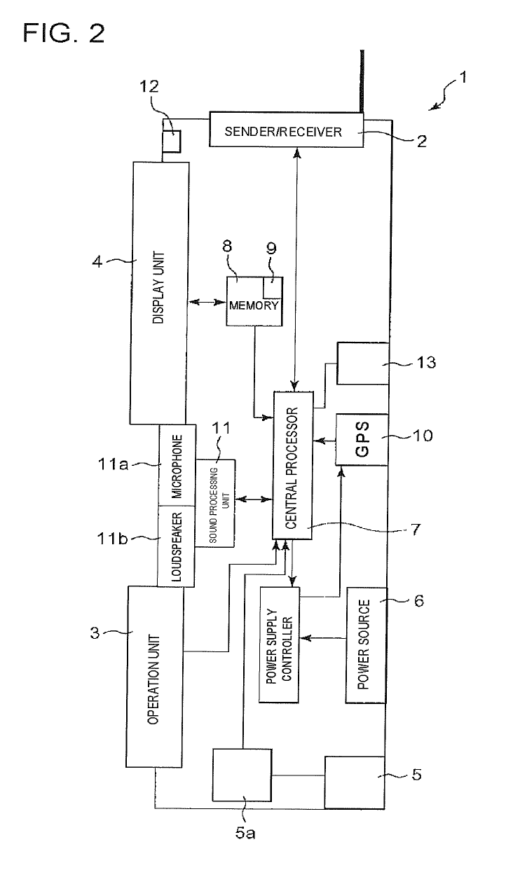

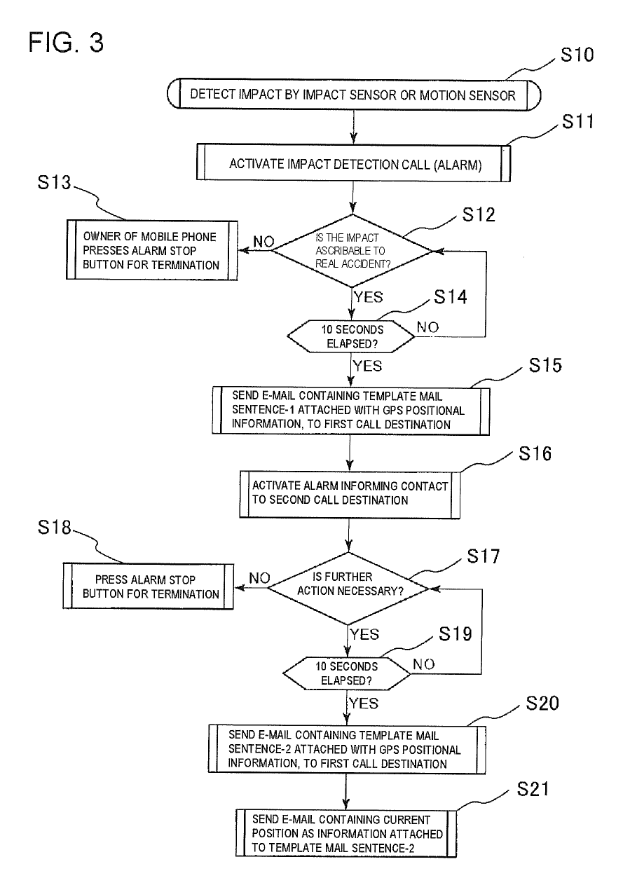

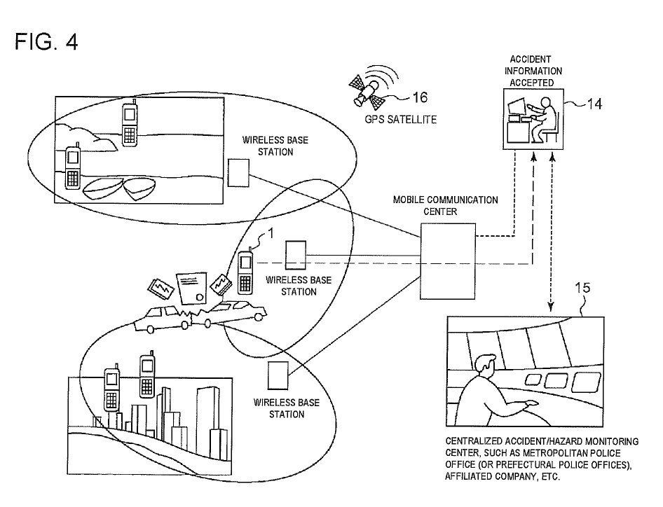

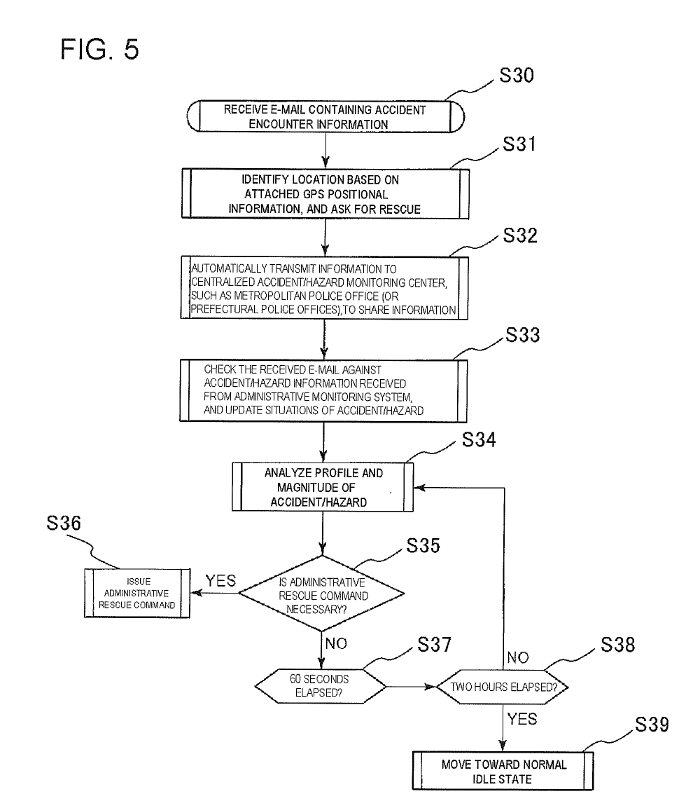

FIG. 1 is a front elevation schematically showing an appearance of the mobile phone device as the mobile terminal device according to an embodiment of the present invention, FIG. 2 is a block circuit diagram of the mobile phone device as the mobile terminal device according to an embodiment of the present invention, FIG. 3 is a flow chart showing processing operations of a program allowing execution of an emergency rescue method using a mobile terminal device according to an embodiment of the present invention; FIG. 4 is a schematic drawing of the entire configuration of an emergency rescue call system according to an embodiment of the present invention; and FIG. 5 is another flow chart showing processing operations of a program allowing execution of an emergency rescue method using a mobile terminal device according to an embodiment of the present invention, wherein the same constituents in the individual drawings will be given with the same reference numerals.

As shown in FIG. 1 and FIG. 2, a mobile phone device 1 is attached with a sender/receiver 2, provided with an operation unit 3 composed of buttons and so forth, and further with a display unit 4. The mobile phone device 1 additionally has an impact/motion sensor 5 on the back bottom thereof.

The sender/receiver 2 has an automatic sending function, and the operation unit 3 allows the user to operate it, for ON/OFF switching of a power supply 6 of the mobile phone device 1 and data entry. The impact/motion sensor 5 may be configured so as to detect changes in various factors, typically may be configured as being sensitive to environmental temperature, smoke, water and so forth, and may therefore be given as a photo-assisted impact sensor or a humidity-assisted sensor, wherein these sensors may be used in a combined manner. The impact/motion sensor 5 outputs a detection signal to an impact judging unit 5a.

In the mobile phone device 1, there is provided a central processor 7 generally controlling entire functions of the mobile phone device 1. The central processor 7 executes various processes, based on a program stored in a memory 8. The memory 8 has a ROM having programs used for executing the various processes preliminarily stored therein, a RAM providing a work area for the processes, and a non-volatile memory for storing data and so forth entered by the user.

The non-volatile memory of the memory 8 is provided with an address book for automatic sending 9, wherein the address book for automatic sending 9 has a function of selecting a plurality of call destinations. The address book for automatic sending 9 has a unique designated call destination data region 9a and a variable designated call destination data region 9b.

The impact judging unit 5a compares a threshold value preliminarily stored in the memory 8 and is supplied via the central processor 7, with results of detection by the impact/motion sensor 5, and transmits results of comparison to the central processor 7.

The mobile phone device 1 is further provided with a GPS receiver 10, acquires positional information therethrough, and outputs it to the central processor 7.

The mobile phone device 1 is further provided with a sound processing unit 11 having a function of informing detection of impact upon detection thereof, with the aid of alarm sound, and a microphone 11a and a loudspeaker 11b. In addition, it is provided also with a light emitting element unit 12 having a function of informing the detection with the aid of light, and a vibration device 13 having a function of informing the detection with the aid of vibration.

Sending information representing detection of an impact through the sender/receiver 2 can be interrupted by operating a call interruption button (not shown) that is provided to the operation unit 3, or a power source 6.

Upon detection of the impact (alarming), after the elapse of a predetermined length of time, typically 10 seconds, the central processor 7 sends an activation signal activating the sender/receiver 2 having the automatic sending function. The sender/receiver 2 then sends a template mail sentence for emergency call attached with positional information which was input from the GPS receiver 10 to the central processor 7.

For the case where accident encounter information is additionally sent to an affiliated security company, call number XXX (fire station), call number YYY (police station) and so forth, which is noticed by an alarm sound emitted from the loudspeaker 11b of the mobile phone device 1.

Using thus-configured mobile phone device 1, first, a call number or a mail address of the called party to whom the template mail sentence for emergency call is sent is entered through the operation unit 3 while confirming the contents thereof on the display unit 4. The entered data is stored in the unique designated call destination data region 9a which is a non-volatile memory unit of the memory 8a.

In addition, the template mail sentence for emergency call to be sent is entered while confirming the contents thereof on the display unit 4. The entered data is stored in the non-volatile memory unit of the memory 8b.

To the variable designated call destination data region 9b of the memory 8a, designated mailing destination data representing the nearest public institutions are stored while being sequentially updated as the mobile phone device 1 moves, based on positional information acquired through the GPS receiver 10, as being correlated with location of the mobile phone device 1.

When impact is externally applied to the mobile phone device 1 having data stored therein as described in the above, the impact/motion sensor 5 outputs a detection signal based on the magnitude of impact, the output is compared in the impact judging unit 5a with the threshold value data read out from the memory 8, and if the output is larger than the threshold value, the central processor 7 reads the designated mailing destination data of the called party to whom the template mail sentence for emergency call is sent, out from the unique designated call destination data region 9a and the variable designated call destination data region 9b of the memory 8a, and also reads data of the template mail sentence for emergency call out from the memory 8b to thereby construct mail sentences, and sends it to the mail address read out from the memory 8a through the sender/receiver 2.

The central processor 7 at this time links the template mail sentence data for emergency call read out from the memory 8b with positional information acquired through the GPS receiver 10, constructs mail sentences, and sends it to the mail address through the sender/receiver 2.

Process operations of a program allowing a mobile terminal, typically the above-described mobile phone device 1, to execute an emergency rescue method will be explained referring to the flow chart in FIG. 3.

When the impact/motion sensor 5 detects an impact as strong as being possibly felt by activation of an air bag of vehicle (step S10), the impact detection call (alarm) is activated, and the detection is informed through alarm sound, emission of light from the light emitting element unit 12, and vibration of the vibration device 13 (step S11). On the other hand, if the impact was not caused by accident but merely by dropping or the like (NO in step S12), the alarm should be canceled by the owner of the mobile phone device 1 by pressing down an alarm stop button (not shown) (step S13).

If the alarm was not canceled within 10 seconds (YES in step S12 and YES in step S14), a template mail sentence-1 in the template mail sentence data for emergency call read out from the memory 8b is attached with a GPS positional information. An electrical mail containing the template mail sentence-1 attached with the GPS positional information is sent to a first call destination (home, for example) (step S15). Data representing the first call destination is stored in the unique designated call destination data region 9a which is a non-volatile memory unit of the memory 8a. The template mail sentence-1 typically has a content of “Got into accident. Keep in touch.”, to which the GPS positional information is attached.

Upon completion of the mailing, an alarm (siren sound, for example), notifying that the next contact will be made to a second call destination [affiliated security company, the nearest call number (fire station) and call number (police station)] through the loudspeaker 11b (step S16). If the owner of the mobile phone device 1 judged at this time that a further action is not necessary (NO in step S17), the owner can press the alarm stop button (not shown) to interrupt further sending of information (step S18).

If the interruption has not been made within 10 seconds (YES in step S17 and YES in step S19), a template mail sentence-2 in the template mail sentence data for emergency call read out from the memory 8b is attached with a GPS positional information. An electrical mail containing the template mail sentence-2 attached with the GPS positional information is sent to a second call destination (step S20). The second call destination can include one or more mail addresses for emergency call destinations. Data representing the second call destination is stored in the variable designated call destination data region 9b which is a non-volatile memory unit of the memory 8a. The stored data is dynamically updated to the designated mailing destination data specifying the nearest public institutions as the mobile phone device 1 moves, based on positional information acquired by the GPS receiver 10, as being correlated with a current location of the mobile phone device 1.

An electrical mail containing the template mail sentence-2 attached with a current positional information is sent (step S21). More specifically, the template mail sentence-2 includes a typical sentence such as “Got into accident. Need urgent help.” which is attached with a positional information.

The alarm may still sound when a rescue team arrives, and this helps the rescue team to quickly find where the owner of the mobile phone device 1 lies.

Next, operations at the second call destination 14 including affiliated security company, the nearest call number XXX (fire station), call number YYY (police station) and so forth will be explained, referring to a schematic drawing of FIG. 4 showing the entire configuration of a rescue call method, and a flow chart of FIG. 5.

When the second call destination 14 such as the affiliated security company, the nearest call number XXX (fire station), the call number YYY (police station) and so forth, receives e-mail containing accident encounter information (step S30), the second call destination 14 also functions as an acceptance unit for accident information, identifies a location of the site of accident based on the GPS positional information attached to the mail of accident encounter information, and calls out rescue (step S31).

The electrical mail of accident encounter information is then automatically sent to a centralized accident/hazard monitoring center 15 having a function of judging state of accident, which is a control center exemplified by the Metropolitan Police Office, Prefectural Police Offices and so forth, to thereby share the information (step S32).

A centralized accident/hazard monitoring center 15, such as the Metropolitan Police Office, Prefectural Police Offices and so forth, which received the automatically the electrical mail containing the accident encounter information, collates the accident encounter information with accident/hazard information based on one or more satellite images directly received from GPS 16 in the administrative monitoring system, and updates situations of the accident/hazard (step S33).

At the same time, the centralized accident/hazard monitoring center 15 also analyzes profile, magnitude and so forth of the accident/hazard (step S34), and judges whether an administrative rescue command calling for rescue by the Self-Defense Forces or the like is necessary (step S35), besides rescue by the second call destination 14 such as the nearest call number XXX (fire station) and the call number YYY (police station).

If the administrative rescue command calling for rescue by the Self-Defense Forces or the like is necessary (YES in step S35), the centralized accident/hazard monitoring center 15 issues the administrative rescue command (step S36), wherein whether issuing of the administrative rescue command is necessary or not is judged every 60 seconds thereafter (step S37), and the situation is settled to the normal idle state after 2 hours (YES in step S38 and step S39).

In the emergency rescue method executed by using the mobile phone device 1 of the present invention, another possible configuration may be such as activating an impact detection call (alarm) upon detection of impact by the impact/motion sensor 5, and repeating a message by voice of “Call number XXX (fire station) will just be called. Call number XXX (fire station) will just be called.”, in place of using the alarm sound for notification.

Still another configuration may be such that the contact is made directly to the second call destination such as an affiliated security company, fire station, police station and so forth, without going through the first call destination, wherein the mobile phone device 1 may be configured as being turned into the automatic response mode or hands-free mode when a call was received from the rescue team or home, so as to allow the owner to communicate without holding the mobile phone device 1, because sustained alarm sound means that the owner is in “serious condition”.

The mobile phone device 1 can be configured still also so that manual sending of information is available so as to allow urgent sending therethrough, even when the accident was not so large as the impact/motion sensor 5 can detect.

Mounting of sensors other than the impact/motion sensor 5, such as those sensitive to temperature (on the supposition of fire hazard, distress in winter mountain, and so forth), smoke (fire hazard), water (drowning) and so forth, may make the mobile phone device 1 adoptable to a wider range of situations of accident.

The second call destination 14, which received information of accident, collates satellite images collected based on the GPS positional information before and after the accident, judges whether occurrence of accident is true or false, and is allowed to understand detailed situation if the accident was judged as really occurred.

The embodiments have been explained referring to the mobile phone device, whereas the emergency rescue call system using the mobile terminal device, and the emergency rescue method using the mobile terminal device of the present invention may not be limited to those making use of the mobile phone device, but may be configured as using a mobile terminal device which is a navigation system mounted on vehicles for personal use, a mobile terminal device traveling as being mounted on public transport facilities including train, bus, ship and so forth, or a mobile terminal device traveling as being mounted on elevator.

What is claimed is:

1. An emergency rescue system comprising:
a mobile terminal device including:
a memory which stores data representing a predetermined designated call destination and data representing a template mail sentence for emergency call;
a sender unit capable of sending an electrical mail;
an abnormality sensor which detects an abnormality in an outer environment;
a GPS receiver which generates GPS positional information; and
a control unit which judges whether a level of sensing of the abnormality sensed by said abnormality sensor is not smaller than a predetermined threshold value, said control unit, if the level is judged as being not smaller than the threshold value, reading said data representing a template mail sentence for emergency call and said data representing a predetermined designated call destination from said memory, and causing said sender to send an electrical mail containing the read data representing the template mail sentence together with said GPS positional information attached to the template mail sentence, to an address specified by the read data representing the designated call destination; and
a control center which judges a state of accident based on both a satellite image and said GPS positional information attached to the template mail sentence received from said mobile terminal device.

2. The emergency rescue system as claimed in claim 1, wherein said abnormality sensor senses at least one abnormality selected from an externally-applied impact, environmental temperature, smoke and water.

3. The emergency rescue system as claimed in claim 1, wherein:
said data representing the designated call destination contains data representing either or both of a unique designated call destination and a variable designated call destination; and
said control unit updates said variable designated call destination to a nearest call destination based on said GPS positional information.

4. The emergency rescue system as claimed in claim 3, wherein:
said data representing the unique designated call destination contains data representing at least one of affiliated companies, family and home; and
said data representing the variable designated call destination contains data representing at least one of a nearest police station, fire station and hospital at the time of accident.

5. The emergency rescue system as claimed in claim 1, wherein said mobile terminal device has either one or both of a notifier and a sound generator, said notifier notifying of contents of said template mail sentence and an emergency message in an artificial voice, and said sound generator generating an alarm sound.

6. The emergency rescue system as claimed in claim 1, wherein said mobile terminal device is capable of operating in a hands-free mode.

7. A mobile phone device comprising:
a memory which stores data representing a predetermined designated call destination and data representing a template mail sentence for emergency call;
a sender unit capable of sending a mail;
an abnormality sensor which detects an abnormality in an outer environment;
a GPS receiver which generates GPS positional information; and
a control unit which judges whether a level of sensing of the abnormality sensed by said abnormality sensor is not smaller than a predetermined threshold value, said control unit, if the level is judged as being not smaller than the threshold value, reading said data representing a template mail sentence for emergency call and said data representing a predetermined designated call destination from said memory, and causing said sender to send an electrical mail containing the read data representing the template mail sentence, to an address specified by the read data representing the designated call destination,
wherein:
said data representing the designated call destination contains data representing either or both of a unique designated call destination and a variable designated call destination; and
said control unit updates said variable designated call destination to a nearest call destination based on said GPS positional information.

8. The mobile phone device as claimed in claim 7, wherein:
said data representing the unique designated call destination contains data representing at least one of affiliated companies, family and home; and
said data representing the variable designated call destination contains data representing at least one of a nearest police station, fire station and hospital at the time of accident.

9. The mobile phone device as claimed in claim 7, wherein said GPS positional information is attached to the template mail sentence.

10. The mobile phone device as claimed in claim 7, wherein said abnormality sensor senses at least one abnormality selected from an externally-applied impact, environmental temperature, smoke and water.

11. The mobile phone device as claimed in claim 7, further comprising either one or both of a notifier and a sound generator, said notifier notifying of contents of said template mail sentence and an emergency message in an artificial voice, and said sound generator generating an alarm sound.

12. The mobile phone device as claimed in claim 7, having a function of operating in a hands-free mode.

13. An emergency rescue method using a mobile terminal device which comprises: a memory which stores data representing a predetermined designated call destination and data representing a template mail sentence for emergency call; a sender unit capable of sending an electrical mail; an abnormality sensor which detects an abnormality in an outer environment;
and a GPS receiver which generates GPS positional information, said emergency rescue method comprising: judging whether a level of sensing of the abnormality sensed by said abnormality sensor is not smaller than a predetermined threshold value;
if the level is judged as being not smaller than the threshold value, reading said data representing a template mail sentence for emergency call and said data representing a predetermined designated call destination from said memory, and causing said sender to send an electrical mail containing the read data representing the template mail sentence together with said GPS positional information attached to the template mail sentence, to an address specified by the read data representing the designated call destination; and
judging a state of accident based on both a satellite image and said GPS positional information attached to said template mail sentence received from said mobile terminal device.

14. The emergency rescue method as claimed in claim 13, wherein said abnormality sensor senses at least one abnormality selected from an externally-applied impact, environmental temperature, smoke and water.

15. The emergency rescue method as claimed in claim 13, further comprising updating a variable designated call destination to a nearest call destination based on said GPS positional information,
wherein said data representing the designated call destination contains data representing either or both of a unique designated call destination and said variable designated call destination.

16. The emergency rescue method as claimed in claim 15, wherein:
said data representing the unique designated call destination contains data representing at least one of affiliated companies, family and home; and
said data representing the variable designated call destination contains data representing at least one of a nearest police station, fire station and hospital at the time of accident.

17. The emergency rescue method as claimed in claim 13, wherein said mobile terminal device has either one or both of a notifier and a sound generator, said notifier notifying of contents of said template mail sentence and an emergency message in an artificial voice, and said sound generator generating an alarm sound.

18. The emergency rescue method as claimed in claim 13, wherein said mobile terminal device is capable of operating in a hands-free mode.

19. A computer program product for emergency rescue which is executed by a processor by using a mobile terminal device including:
a memory which stores data representing a predetermined designated call destination and data representing a template mail sentence for emergency call;
a sender unit capable of sending an electrical mail;
an abnormality sensor which detects an abnormality in an outer environment;
a GPS receiver which generates GPS positional information; and
a control unit which judges whether a level of sensing of the abnormality sensed by said abnormality sensor is not smaller than a predetermined threshold value, said control unit, if the level is judged as being not smaller than the threshold value, reading said data representing a template mail sentence for emergency call and said data representing a predetermined designated call destination from said memory, and causing said sender to send an electrical mail containing the read data representing the template mail sentence together with said GPS positional information attached to the template mail sentence, to an address specified by the read data representing the designated call destination,
said computer program product comprising:
code for receiving said GPS positional information from said mobile terminal device attached to the template mail sentence; and
code for judges a state of accident based on both a satellite image and the received GPS positional information.
